(19) United States
(12) Patent Application Publication
(10) Pub. No.: US 2007/0260703 A1
(43) Pub. Date: Nov. 8, 2007

(54) METHODS AND SYSTEMS FOR TRANSMISSION OF SUBSEQUENCES OF INCREMENTAL QUERY ACTIONS AND SELECTION OF CONTENT ITEMS BASED ON LATER RECEIVED SUBSEQUENCES

(76) Inventors: Sankar Ardhanari, Windham, NH (US); Viswanathan Thiagarajan, Bangalore (IN); Gurudutt Pai, North Andover, MA (US); Murali ARAVAMUDAN, Windham, NH (US); Kajamalai G. RAMAKRISHNAN, Nashua, NH (US); Ravi Krishna, Bangalore (IN)

Correspondence Address: WILMER CUTLER PICKERING HALE AND DORR LLP, 60 STATE STREET, BOSTON, MA, 02109, US

(21) Appl. No.: 11/627,426

(22) Filed: Jan. 26, 2007

Related U.S. Application Data
(60) Provisional application No. 60/762,709, filed on Jan. 27, 2006.

(51) Int. Cl. G06F 15/16

(52) U.S. Cl. 709/217

(57) ABSTRACT

The invention features a method of reducing perceived network latency in processing a query from a handheld client device processed by a remote system. The client device receives incremental input including a sequence of incremental user actions for identifying content items on the remote system. The client device transmits a first subsequence of the input to the remote system for incrementally identifying descriptive terms associated with desired content items. The remote system selects a first set of content items based on the first subsequence and transmits them in a reply to the client device. The client device selects a second set of content items from the first set based on a second subsequence of the input. The second subsequence includes incremental input received by the client device while it was waiting for the first reply. The client device orders and presents the second set of content items to the user.

### CROSS-REFERENCE TO RELATED APPLICATIONS

This application claims the benefit under 35 U.S.C. §119(e) of U.S. Provisional Patent Application No. 60/762,709, filed on Jan. 27, 2006, entitled A Method Of Selective Retransmission and Cumulative Dispatch Of Unanswered User Requests During Navigation Of Remotely Resident Information, which is herein incorporated by reference in its entirety.

### BACKGROUND

1. Field of Invention

The present invention relates to performing incremental finds on a remote server system in response to incremental user query input on a handheld client device. More particularly, the invention relates to transmitting subsequences of a sequence of incremental query actions to the remote server system and processing on the client device a set of content items returned by the remote server system based on later received, more complete, subsequences of incremental query actions.

2. Description of Related Art

The challenges to build a responsive user interface on televisions and mobile devices for navigating remotely resident information are many, most noteworthy of which is the network bandwidth constraints and round-trip latencies. User interface studies have shown that the brain perceives response latencies when the response to a user input exceeds 150-200 milliseconds. Existing devices that perform searches on remotely resident information typically queue the user's queries as well as the responses from the remote system. Thus, the user must wait for all queued queries and results to be processed in order to obtain results to the most recent query entry.

Delivering remotely resident content in a timely manner is also important in streaming media delivery applications. Applications using datagram protocols send the media as a series of small packets. Although simple, this method is susceptible to packet loss, which results in missing data. Various error correction techniques are employed in an effort to reduce the impact of this missing data. The use of Transmission Control Protocol (TCP) in streaming applications helps to reduce packet loss, but applications using this protocol suffer from reduced throughput. Client applications can minimize these negative effects by buffering data for presentation to the user.

### SUMMARY

In one aspect, the invention features a method of reducing perceived network latency in processing a minimal prefix text search query or a browse action from an input constrained handheld client device and processed by a remote server system and presenting results therefrom. The handheld client device receives incremental input including a sequence of incremental user actions for identifying desired content items on the remote server system, the incremental input incrementally identifies descriptive terms associated with the desired content items. The handheld client device transmits a first subsequence of the incremental input to the remote server system. The remote server system receives the first subsequence and selects a first set of content items based on the first subsequence and the descriptive terms associated with the content items and transmits a reply including the first set of content items to the handheld client device. The handheld client device receives the first set of content items and selects a second set of content items from the first set based on a second subsequence of the incremental input. The second subsequence is larger than the first subsequence and includes incremental input received by the handheld client device while it was waiting for the reply to the first subsequence. The handheld client device orders the second set of content items for presentation in accordance with one or more criteria and presents the ordered set to the user.

In another aspect of the invention, the handheld client device transmits the second subsequence of the incremental input to the remote server system. The remote server system receives the second subsequence, selects a third set of content items based on the second subsequence and the descriptive terms associated with the content items, and transmits a reply including the third set of content items to the handheld client device.

In yet another aspect of the invention, the handheld client device transmits the second subsequence of the incremental input to the remote server system if a time threshold has elapsed. In another aspect, the time threshold is an average amount of time for the remote server system to reply to a transmission from the handheld client device.

In a further aspect of the invention, the handheld client device monitors an input latency for each incremental user action. Each input latency is an amount of time between consecutive incremental user actions. The sizes of the subsequences are based on the input latency for incremental user actions.

In another aspect of the invention, the first subsequence includes all incremental user actions for identifying the desired content items that are entered before the user pauses for a time greater than a predetermined threshold. In another aspect, the predetermined threshold is an average input latency for the user to incrementally input a user action.

In yet another aspect of the invention, at least one of the handheld client device and the remote server system monitors an average network roundtrip latency. The average network roundtrip latency is an average amount of time for the remote server system to reply to a transmission from the handheld client device. The sizes of the subsequences are based on the average network roundtrip latency.

In yet another aspect of the invention, the handheld client device transmits a self-sufficient message to the remote server system. The self-sufficient message includes the first subsequence and all relevant context for the first subsequence including previous subsequences, if any, so that the remote server system does not need information in a previous message to respond to the self-sufficient message. In another aspect, the handheld client device formats messages for transmission to the remote server system to be less than a predetermined size.

In a further aspect of the invention, the incremental input consists of text entry only, browse actions only, or a combination of text entry and browse actions. In another aspect, the incremental input includes ambiguous text input.

In one aspect, the invention features a method of reducing perceived network latency in processing a minimal prefix text search query or a browse action from an input constrained handheld client device and processed by a remote server system and presenting results therefrom. The handheld client device receives incremental input including a sequence of incremental user actions for identifying desired content items on the remote server system. The incremental input incrementally identifies descriptive terms associated with the desired content items. The handheld client device transmits a first subsequence of the incremental input to the remote server system. The remote server system receives the first subsequence and selects a first set of content items based on the first subsequence and the descriptive terms associated with the content items and transmits a reply including the first set of content items to the handheld client device. The handheld client device transmits a second subsequence of the incremental input to the remote server system. The second subsequence is larger than the first subsequence and includes incremental input received by the handheld client device while it was waiting for the reply to the first subsequence. The remote server system receives the second subsequence and selects a second set of content items based on the second subsequence and the descriptive terms associated with the content items and transmits a reply including the second set of content items to the handheld client device. The handheld client device receives the first and second set of content items and aborts processing on the set of content items corresponding to the subsequence transmitted earlier in time. The handheld client device selects a third set of content items from the set of content items corresponding to the subsequence transmitted later in time based on a third subsequence of the incremental input. The handheld client device orders the third set of content items for presentation in accordance with one or more criteria and presents the ordered set to the user.

In another aspect of the invention, the second subsequence and the third subsequence are the same subsequence. In a further aspect, the third subsequence is larger than the second subsequence and includes incremental input received by the handheld client device while it was waiting for the reply to the second subsequence.

### BRIEF DESCRIPTIONS OF DRAWINGS

For a more complete understanding of various embodiments of the present invention, reference is now made to the following descriptions taken in connection with the accompanying drawings in which:

FIG. 1 illustrates a keypad with overloaded keys.

FIG. 2 illustrates a reduced text entry search system in accordance with one or more embodiments of the invention being used in a network configuration with round trip latencies and packet losses.

FIG. 3 illustrates device configuration options to perform navigation of remotely resident information.

FIG. 4 illustrates a flow chart for the selective retransmission of unanswered requests.

FIG. 5 illustrates a node arrangement for searching for content items using browse actions.

FIG. 6A illustrates an instance of a mobile device interface used to perform navigation of remotely resident information.

FIG. 6B illustrates the various states user can transition through to arrive at the desired result through navigation of remotely resident information.

FIG. 7 illustrates the various node traversals possible on a graph of information nodes. In this illustration a directed acyclic graph of nodes are shown for elucidatory purposes.

FIG. 8 illustrates state transitions possible when user inputs a new navigation request before the system responds to a previous user request.

### DETAILED DESCRIPTION

Incremental search is a method of searching a catalog of items by displaying results that correspond to each user input action before the user has entered the entire search input. For example, if a user is entering a text string as a query, a system using an incremental search technique responds with results corresponding to each string formed as the user enters each character, for example, for a query string “Browns”, the strings formed during entry of the complete string are “B”, “Br”, “Bro”, “Brow”, “Brown”, and “Browns”. One type of incremental search system useful with input and/or display constrained devices includes inputting search criteria on the device, which then communicates over a network with a remote server that contains a catalog of items. Latencies in the request/response round trip can cause significant delays in the overall search experience for the user, as the user's device must wait for each response before processing the next query string portion.

Embodiments of the invention reduce the user's perceived latency of response of a remote server to a request made by a user's device performing an incremental search. The user's device either retransmits unanswered requests or drops the unanswered request and transmits an updated cumulative request based on a comparison of (1) the average round trip latency of a request/response and (2) the average latency between the user's query actions, e.g., the time between key presses in a text-based query. When query results corresponding to an earlier query are received after additional query input has been provided, the user's device filters these results using the later-received query entries to provide a set of results considered relevant to the most recent query input.

This concept is described in greater detail below, but a simple example includes a search in which the user intends to enter the search string “CAR”. After the “C” is entered, the user's device sends the search string “C” to the remote server. The remote server performs an incremental find using the input “C” and sends results to the user's device. However, before the user's device receives results corresponding to the search string “C”, the user completes the query entry by typing the remaining letters “A” and “R”. Upon receiving the search results for “C”, the user's device applies the entire current query input, i.e., “CAR”, to the result set and presents only the results corresponding to the entire input “CAR”.

In order to achieve apparent “real-time response”, the techniques herein focus on the timely delivery of response data in contrast to the reliable delivery of response data. A response that does not arrive in a timely manner is almost equivalent to not having arrived at all because it would not meet the key requirement of the navigation system—the feel of real-time response. In addition, retransmission of the request corresponding to the delayed response would only delay further requests and/or responses on the network.

Embodiments include transporting self-contained data packets for requests and responses to eliminate packet dependency. Thus, the techniques described herein ensure packet loss does not require retransmission of an earlier packet due to the subsequent packets being dependent on an earlier packet that has been lost. This concept is described in greater detail below, however, the following example is provided. In the case of a search string “BROWNS” being divided into two packets, the first containing the letters “BRO” and the second containing “WNS”, if the first packet was lost, only the letters “WNS” would be received by the remote server. Thus, the query input would be incomplete, resulting in incorrect search results.

Another embodiment of the invention enables the system to accept user input, even if the user's navigation rate is faster than the system's response rate. Slowing the user's navigation by forcibly synchronizing user input with the response rate would also erode the feeling of real-time response. The system permits the user, whenever meaningful, to provide input ahead of the system's response rate. It then processes any received results to respond to the most recent user input, as described above, thereby emulating the cumulative effect of all of the preceding requests whose responses are still unanswered without incurring “streaming” penalties, e.g., those due to TCP queues.

Embodiments of the present invention build on techniques, systems and methods disclosed in earlier filed applications, including but not limited to U.S. patent application Ser. No. 11/136,261, entitled Method and System For Performing Searches For Television Programming Using Reduced Text Input, filed on May 24, 2005, U.S. patent application Ser. No. 11/235,928, entitled Method and System For Processing Ambiguous, Multiterm Search Queries, filed on Sep. 27, 2005, U.S. patent application Ser. No. 11/356,788, entitled Method and System For Offsetting Network Latencies During Incremental Searching Using Local Caching And Predictive Fetching of Results From A Remote Server, filed on Feb. 17, 2006, and U.S. patent application Ser. No. 11/246,432, entitled Method And System For Incremental Search With Reduced Text Entry Where The Relevance Of Results Is A Dynamically Computed Function of User Input Search String Character Count, filed on Oct. 7, 2005, the contents of which are hereby incorporated by reference. Those applications taught specific ways to perform incremental searches using ambiguous text input and methods of reducing the perceived latency of a response from a remote server. The present techniques, however, are not limited to systems and methods disclosed in the incorporated patent applications. Thus, while reference to such systems and applications may be helpful, it is not believed necessary to understand the present embodiments or inventions.

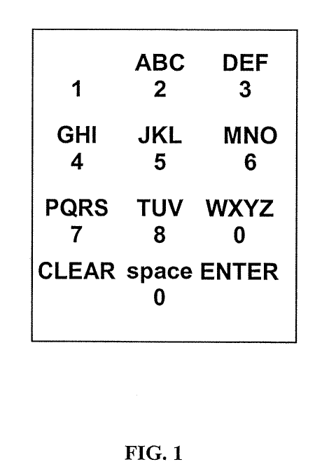

FIG. 1 illustrates an example of a keypad of a user input device for use with embodiments of the invention. Embodiments of the invention can be used with input devices that have overloaded keypads that provide ambiguous text strings, wherein a press of a single key of the keypad represents multiple letters and/or numerals. Likewise, embodiments can use traditional keypads or keyboards providing nonambiguous input.

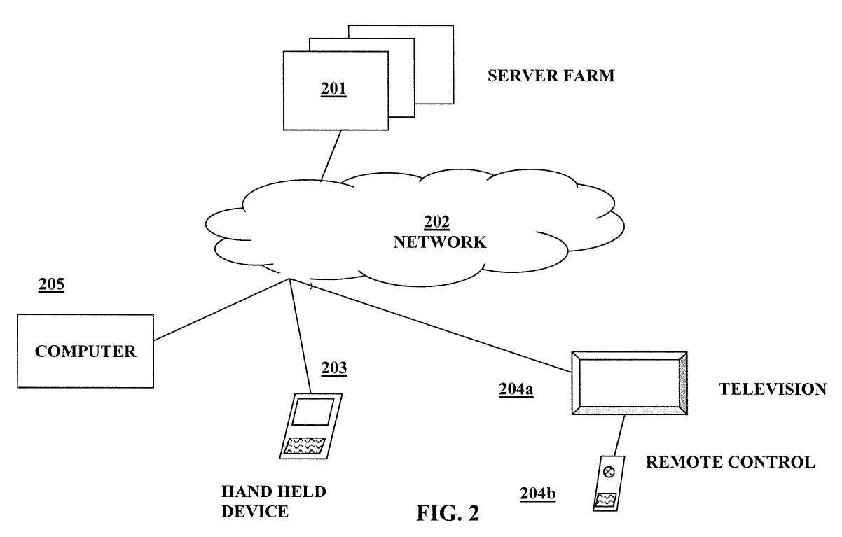

FIG. 2 illustrates a system for query and navigation of network resident information using a wide range of devices in accordance with one or more embodiments of the invention. A server farm 201 serves as the source of information and relevance updates. Network 202 functions as the distribution framework and can be a combination of wired and wireless connections. The navigation devices can have a wide range of interface capabilities and include such devices as a hand-held device 203 (e.g. phone, PDA, or a music/video playback device) with limited display size and an overloaded or small QWERTY keypad, a television 204a coupled with a remote 204b having an overloaded or small QWERTY keypad, or a personal or laptop computer 205.

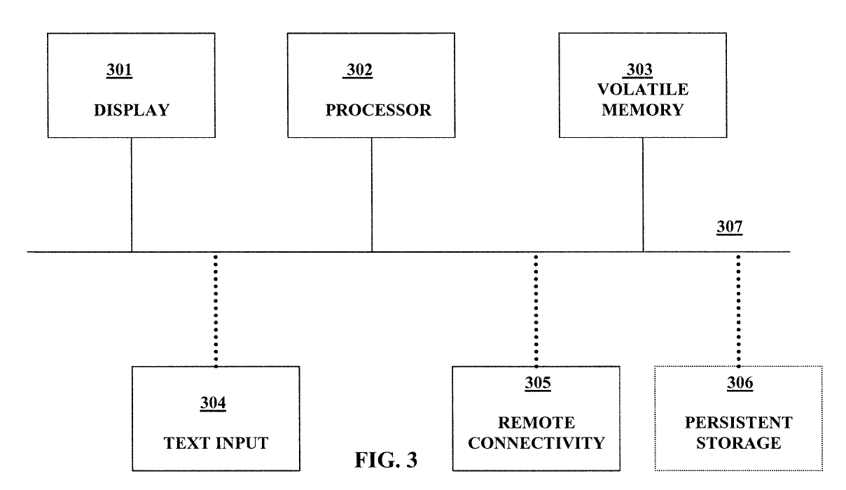

FIG. 3 illustrates multiple device configurations for use with embodiments of the invention. In one configuration, the navigation device 203 of FIG. 2 has a display 301, a processor 302, volatile memory 303, a text input interface 304, which is on-device, remote connectivity 305 to the server farm 201 through the network 202, a persistent storage 306. In another device configuration, the device 203 may not have local persistent storage 306. In such a scenario, the device 203 would have remote connectivity 305 to submit the query to the server farm 201 and retrieve results from it. In another configuration of the device 203, it does not have remote connectivity 305. In this scenario, the navigation database is locally resident on a local persistent storage 306. The persistent storage 306 can be a removable storage element, such as SD, SmartMedia, CompactFlash card etc. In a configuration of the device 203 with remote connectivity 305 and persistent storage 306 for navigation, the device 203 may use the remote connectivity for search/browse, relevance data updates, or for the case where the navigation database is distributed on the local storage 306 and on the server farm 201.

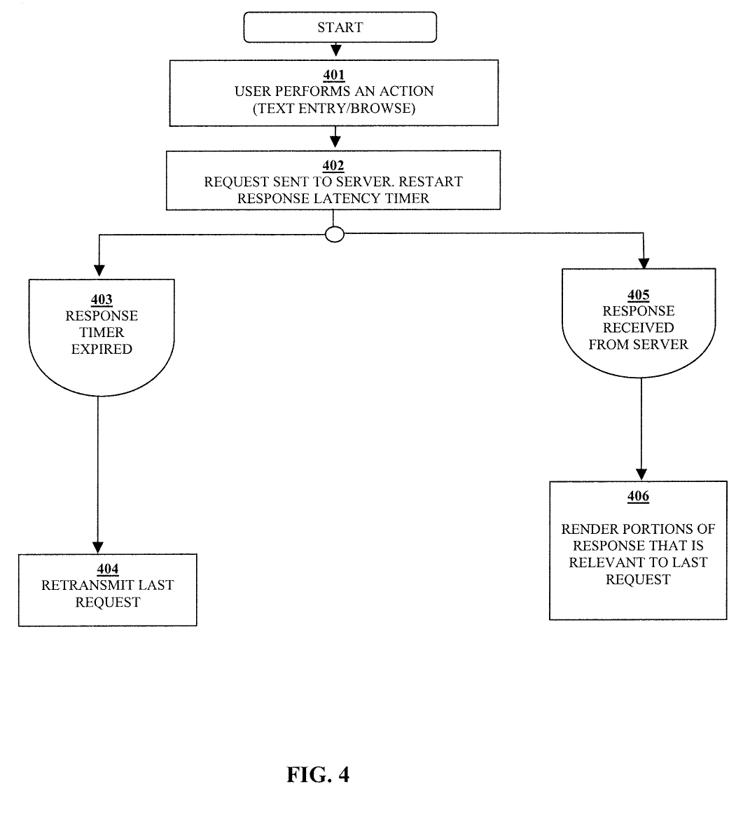

FIG. 4 illustrates a flow chart for the selective retransmission of unanswered requests. The user performs a navigation action (step 401), which could be a browse or search action performed on the user's device. In this context, a browse action is essentially a traversal of a tree of information nodes, while a search action is text entry. In an embodiment of the invention, the search process for text entry is based on an incremental search where results are shown as the user types in each character of the input string. In a basic incremental search implementation, when the user enters the text “C”, the system responds with results correspond to the text “C”. When the user enters a further letter, “A”, the system responds with results corresponding to the text “CA”. Depending upon the search engine design, this “CA” can be the first letters in the title of each result item, or the “CA” can be the first letters of a keyword associated with each result item.

In the illustrative embodiment, the user's requests are sent to the server (step 402), at which point the user's device begins to track the time for the corresponding response to arrive from the server. If the response is not received within the greater of (1) the average inter-navigation latency, that is, the amount of time between button presses on the user's device and (2) the average round-trip latency between transmission of a query and receipt of the corresponding response (described below), the system transmits a new request to the server (step 404). However, as explained in greater detail below, the new request is a cumulative request that captures the query information from the unanswered request as well as any new query information that the user has entered after the transmission of the initial request. In contrast, if a response is received from the server within the greater of the two latency periods (step 405), the system presents only those results that are relevant to both the initial query information and the later-entered query information. For example, the user enters “T” followed by “O”. The remote server responds by sending to the user's device a set of content items that have associated descriptive terms beginning with the letter “T”. In this example, the user's device receives the response corresponding to “T” after “O” is pressed. Thus, the user's device would select for presentation only those content items that have associated descriptive terms beginning with the letters “TO” (step 406).

As mentioned above, the user's device utilizes the average inter-navigation latency and the average round-trip latency between transmission of a query and receipt of the corresponding response to determine when to transmit a new request to the server. The user's device gathers information about these two latency parameters and continually calculates a rolling average for each parameter. A query processing server can also determine the average round-trip latency in the same manner. Because the average round-trip latency can change very rapidly due to fluctuating network conditions, the window for this rolling average is relatively small, for example, on the order of seconds to minutes. However, because the average inter-navigation latency of the user is expected to change very little over time, the window for this rolling average is relatively large. This reflects the expectation that the user's typing speed and/or browsing speed is relatively constant. Thus, the window for this rolling average, for example, can be on the order of hours to days.

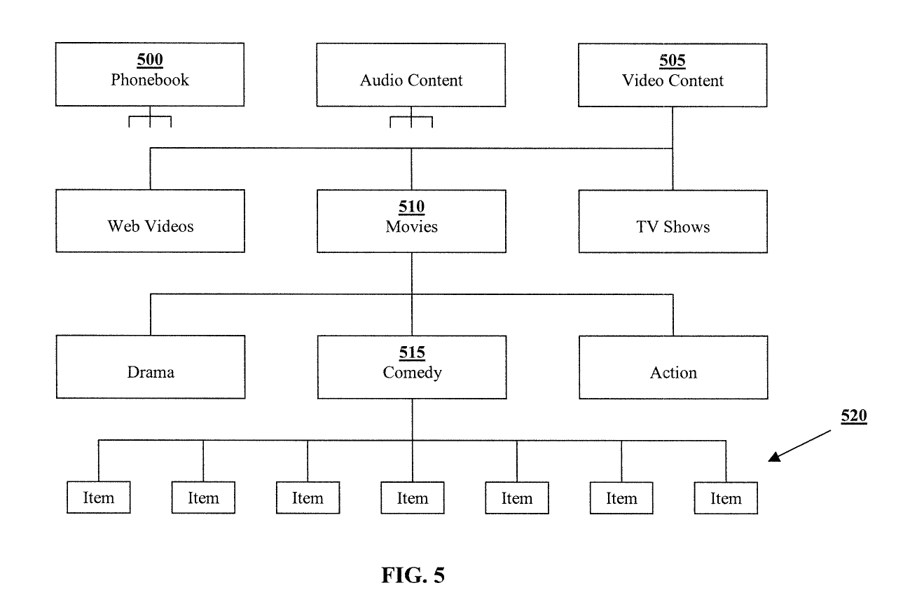

Typically, when the user is navigating the system using only browse actions, e.g., ascending, descending, and traversing nodes of a tree arrangement, the user must wait until the system responds with results in order to know what nodes are available for selection. However, after repeated use, the user may become familiar enough with the system to remember the arrangement of node categories (such as the example shown in FIG. 5), even though the content items in the categories may change. Indeed, even in a system that is continuously updated, the arrangement of the node categories is likely to remain unchanged for some amount of time. Thus, even though the user's device has not received a response to a browse action, e.g., a hierarchy of nodes presented to the user, the user may be able to browse several levels by memory. If the node hierarchy has changed or is different than the user's recollection, the user will be able to correct the erroneous browse action when the user's device receives the response and renders the current node hierarchy.

FIG. 5 illustrates an illustrative node arrangement that has category nodes and content items. In one example, the user wishes to browse the system's selection of comedy movies. Through continued use, the user has memorized the arrangement of the category nodes. Thus, the user knows that when he enters the browse navigation mode on his device, the browse cursor is focused on a “Phonebook” node 500. The user also remembers that a “Video Content” node 505 is two selections to the right of Phonebook node 500, and a “Movies” node 510 is one selection down and one selection to the left. Finally, the user recalls that the “Comedy” node 515 is one selection down from Movies node 510. Therefore, the user can rapidly enter in the browse actions of two selections to the right, one selection down, one selection left, and one selection down to arrive at the node for comedy movies.

As described above, if the user completes this sequence of browse actions before the system responds with results within the greater of (1) the average inter-navigation latency and (2) the average round-trip latency, the system queues the browse actions and transmits the entire cumulative sequence of browse actions the user performed as a single request. Likewise, if the user enters a single browse action, which is sent to the system, followed by the remaining browse actions before the system responds to the first single browse action, the user's device drops the first request and sends the cumulative sequence of browse actions as a single request. The system responds to the cumulative request by providing item nodes 520 that correspond to a listing of comedy movies. In addition, the system response includes a listing and arrangement of the category nodes that are higher in the hierarchy than the item nodes, e.g., Drama, Comedy, Action, Web Videos, Movies, TV Shows, Phonebook, Audio Content, and Video Content.

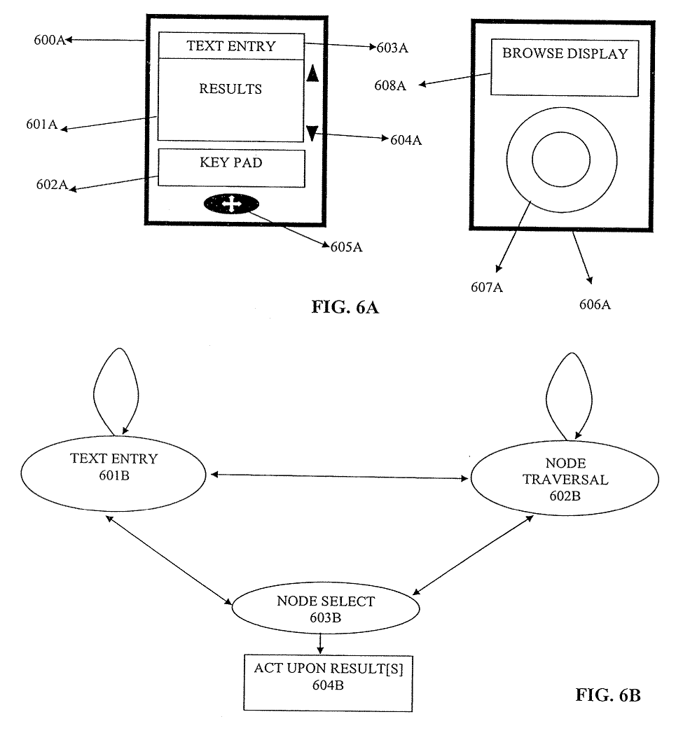

FIG. 6A illustrates a mobile device 600A interface for navigating remotely resident information. The user enters text using a keypad 602A, which may have overloaded keys similar to the 12-key keypad in FIG. 1. The entered text is displayed in the text field 603A. The navigation interface on the device is a navigation button 605A that facilitates movement at least in the horizontal and vertical direction. The results corresponding to the incremental text query or browse actions are displayed in the results area 601A. The user can scroll through the results by using a scroll interface 604A and/or by using the navigation buttons 605A. An alternate scroll interface 607A is shown in a browse only device 606A (e.g. a music player like an IPOD, but where content is remotely resident and the user remotely navigates this content). The browse results are shown in the display 608A.

FIG. 6B illustrates the various states of navigation actions between which the user could freely transition in order to get to the desired result. The user can (1) use text entry exclusively to find results (step 601B), (2) use browse actions, e.g., node traversals, exclusively to find results (step 602B), or (3) use a combination of text entry and browse actions to find results. The actual methods used are influenced by both the user's intent and the information that is displayed. For example, the user can start by entering text (step 601B), scroll through the displayed results (step 602B), pick a non-terminal node (step 603B), and traverse the children of the non-terminal (step 602B). When the user discovers a result, he selects it (step 603B) and performs an appropriate action (step 604B).

A key requirement for transmission of cumulative requests is to make each request self-contained, that is, each request contains all of the query information, whether text entry, browse actions, or both. In other words, the server system that processes the queries is stateless. Thus, each later request does not depend on the system having received an earlier request in order to provide context for the later query. For example, a text entry request sequence can be made self-contained by keeping track of the entire input string and the current node in whose context the current text search was performed (e.g., <node stack context, text input>). Thus, if the user browsed to a video content node and entered a text query, that text query would only be performed in the context of the video content node. Similarly, a browse action request sequence, e.g., a linear scroll action, is made self-contained by making each scroll request an absolute range request, rather than a relative request, by providing the context of the node where the browse was performed (e.g., <node stack context, absolute range query>). A node ascend/descend request can be captured in a similar manner, by providing both the browse action and the context in which it was performed (e.g., <node stack context, node ascend/descend count>). Lastly, a node select request is made self-contained by providing the context within which the selection action is made and the index of the selected node (e.g., <node stack context, select node index>).

Likewise, cumulative combinations of these requests can also be done to make each request self-contained, where contiguous repetitive requests are coalesced into a single request. In scenarios where contiguous requests are not of the same type, the cumulative request can be a sequence of unanswered requests specified as shown above. The user's device assigns a unique identifier to each request and sends this identifier to the system along with the request information. The system includes this unique identifier with the response so that the user's device can keep track of which response is being returned.

These unique identifiers enable the user's device to maintain the state of the system across multiple queries that are sent to the query system. Thus, the user's device would ignore a response to a request that has been superceded by a response to a more recent request. This aspect is especially useful in a system that uses an application switch as an interface between the user's device and a query processing system that uses multiple query processing servers.

For example, an illustrative system utilizes five query processing servers behind an application switch. The user's device sends a first query to the system. The application switch receives the query and routes the query to the first query processing server. Before the first server can respond, the user's device sends a second, more complete, cumulative query to the system, as described above. In an effort to load balance the system, the application switch routes the second query to the second query processing server. Before the first server can respond to the first query, the second server responds to the second query by transmitting a response to the user's device. The user's device checks the unique identifier for the response corresponding to the second query and discovers that it is the first response received for the given sequence of queries. Thus, the user's device presents the response results (and applies any additional query input, as described above, if necessary).

After the user's device has received the response to the second query, the first server responds to the first query by sending a response to the user's device. The user's device checks the unique identifier of this response corresponding to the first query and discovers that it has been superceded by the response corresponding to the second query. Thus, the user's device ignores this response data in favor of the results corresponding to the more recent query.

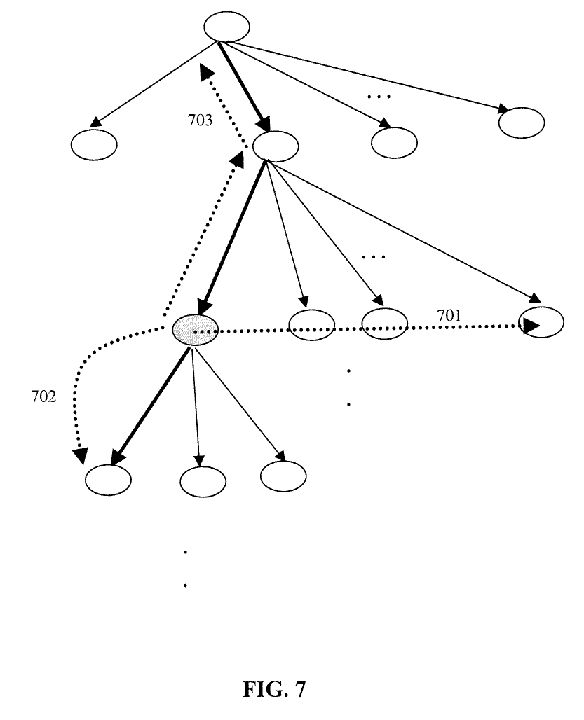

FIG. 7 illustrates the various node traversals possible on a graph of information nodes. In this illustration, a directed acyclic graph of nodes is shown purely for elucidatory purposes. Three forms of possible node traversals are (1) sibling traversal (step 701)—traversal of all edges emanating from a node, (2) node descend (step 702)—traversal to an adjacent node, and (3) node ascent (step 703)—retracing a traversal path to a previous node. Sibling traversals (step 701) can be done from the user's device ahead of the system response to the individual scroll actions because the system response includes all child nodes upon a node descent (step 702). Similarly, an ascent operation (step 703) can be done without waiting for the system to respond to the individual “back” operations because the user's device retains the node hierarchy that it has already descended. However, as explained above, node descend operations (step 702) can be performed by the user ahead of system response only if the user has remembered the node hierarchy, otherwise, the user must wait until the system has responded to a descend action (step 702) in order for the user to perform a subsequent descend.

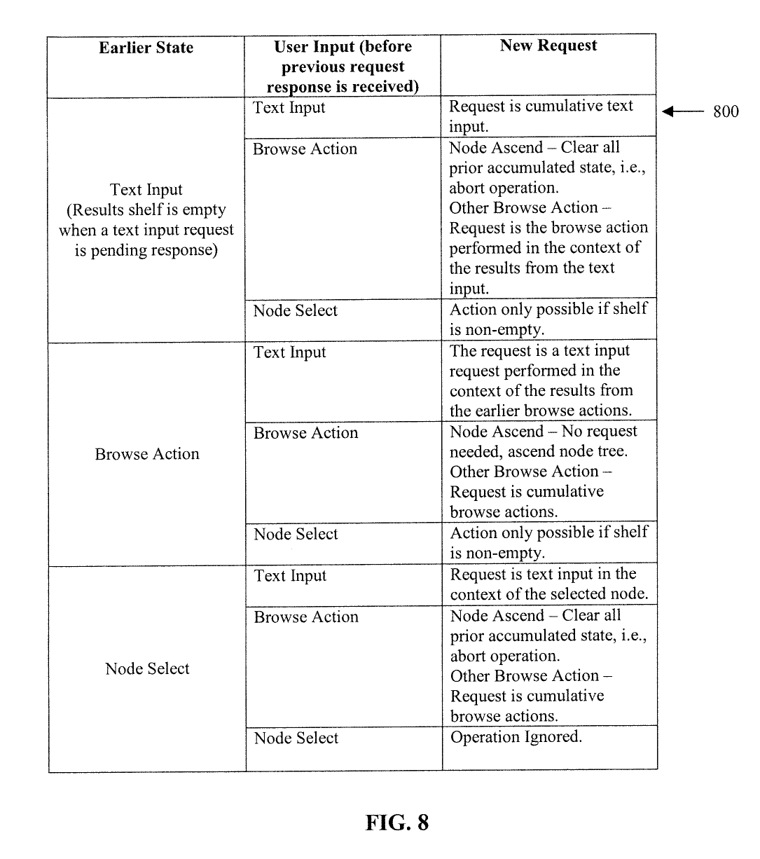

FIG. 8 illustrates the state transitions possible, and resulting new requests, when the user inputs a new navigation request before the system responds to a previous user request. The new user input can be either text entry or browse actions. As explained above, the system accumulates the user actions that occur after a request has been sent. These actions are combined with the action comprising the earlier request to form a self-contained, cumulative request. The system transmits this new self-contained, cumulative request in the event a response has not arrived in the timeout periods as explained in connection with FIG. 4.

Referring to FIG. 8, the first column lists the various states from which the user may transition when he provides additional user input (either text input or browse actions). The second column lists the various forms of input the user can provide while waiting for the system to respond. The third column lists the new request the system will make if the earlier request is not received within the timeout periods described above.

An example of a text input followed by further text input is provided; this corresponds to the first row in FIG. 8 (row 800). The user has entered a text input “movies”. During the text entry, the amount of time between the user pressing “m” and “o” was shorter than the average latency between the user's query actions, but the time between the user pressing “o” and “v” was longer than the average latency between the user's query actions. Thus, the user's device sent a request for results corresponding to “mo”. Before the user's device receives the system's response to this request, the user enters the remaining letters “v”, “i”, “e”, and “s”, all within the average latency between the user's query actions. If the response is not received within the greater of (1) the average round trip latency of a request/response and (2) the average latency between the user's query actions, the user's device sends a new request that is the cumulative text of both entries, i.e., “movies”.

In one illustrative implementation, the selective retransmission system is implemented using UDP (User Datagram Protocol). The time-out for retransmission is dynamically computed, taking into account the inter-navigation latency and the round-trip latency, as described above. Furthermore, the request and response packets are tuned to be the optimal size to minimize fragmentation at lower layers in the protocol stack (e.g., the data link layer and the physical layer of the OSI Reference Model). Because transmission packet sizes in the lower layers in the protocol stack may be governed by various standards, the application layer of the system may not be permitted to directly prevent the division of a single request into multiple packets at these lower layers. However, by tuning packet size, the system can indirectly minimize or eliminate fragmentation of the packets at the lower layers. If fragmentation is eliminated when sending the request, the request is effectively made physically self-contained, that is, a single packet carries the user's request. Each implementation will have different maximum transmission unit (MTU) values for the path between the user's device and the query processing servers depending on the details of the implementation. The particular MTU for a given implementation can be easily determined using known methods. Minimizing fragmentation has the added advantage of reducing the total number of packets sent between the user's device and the remote system elements, thereby reducing network traffic.

Embodiments of the invention can be implemented using TCP. These implementations determine the ideal subsequence size to send based on the average inter-navigation latency and the average round-trip latency. When the round-trip latency is relatively high, the user's device will reduce the number of requests by sending larger subsequences. Such embodiments accumulate each user action of a sequence of user search actions when the user enters each action at the typical user's entry speed (i.e., the average inter-navigation latency). When the user pauses for more than is typical in a string of query actions, the user's device sends the entire cumulative request at once rather than sending each user action separately. Thus, although TCP automatically retransmits lost packets, this illustrative implementation reduces the number of packets that must be sent, thereby reducing the load on the network.

The system can also use a combination of UDP and TCP for transmitting request and response packets. In such an implementation, the user's device sends requests via a UDP channel. Thus, the user's device sends request packets as described above (e.g., taking into account round-trip latency, inter-navigation latency, and superceded techniques). Meanwhile, the user's device receives response packets on both a UDP channel and a TCP channel. The response packets that arrive via the TCP channel are reassembled in the order in which they were sent by the remote query system. Thus, the order in which the content items were arranged by the query system is preserved on the user's device. In contrast, the response packets that arrive via the UDP channel are presented to the user in the order in which they arrive.

By using this combination, the system can implement result-ordering techniques, such as those disclosed in the applications incorporated above, for example. Thus, the content items that are placed within a predetermined number of spots at the top of the result set by the query system are send via the TCP channel. The remaining content items are sent via the UDP channel. The user's device then displays the response results sent via TCP upon receiving the TCP packets and adds the remaining results, sent via the UDP channel, to the result stack as they arrive.

It will be appreciated that the scope of the present invention is not limited to the above-described embodiments, but rather is defined by the appended claims, and these claims will encompass modifications of and improvements to what has been described. For example, embodiments have been described in terms of entering ambiguous text search queries using a 12-key keypad. However, traditional keyboards can be used with embodiments of the invention.

What is claimed is:

1. A method of reducing perceived network latency in processing a minimal prefix text search query or a browse action from an input constrained handheld client device and processed by a remote server system and presenting results therefrom, the method comprising:
the handheld client device receiving incremental input including a sequence of incremental user actions for identifying desired content items on the remote server system, the incremental input incrementally identifying descriptive terms associated with the desired content items;
the handheld client device transmitting a first subsequence of the incremental input to the remote server system;
the remote server system receiving the first subsequence and selecting a first set of content items based on the first subsequence and the descriptive terms associated with the content items and transmitting a reply including the first set of content items to the handheld client device;
the handheld client device receiving the first set of content items and selecting a second set of content items from the first set based on a second subsequence of the incremental input, the second subsequence being larger than the first subsequence and including incremental input received by the handheld client device while it was waiting for the reply to the first subsequence; and
the handheld client device ordering the second set of content items for presentation in accordance with one or more criteria and presenting the ordered set to the user.

2. The method of claim 1, further comprising:
the handheld client device transmitting the second subsequence of the incremental input to the remote server system; and
the remote server system receiving the second subsequence and selecting a third set of content items based on the second subsequence and the descriptive terms associated with the content items and transmitting a reply including the third set of content items to the handheld client device.

3. The method of claim 1, wherein the handheld client device transmits the second subsequence of the incremental input to the remote server system if a time threshold has elapsed.

4. The method of claim 3, wherein the time threshold is an average amount of time for the remote server system to reply to a transmission from the handheld client device.

5. The method of claim 1, further comprising the handheld client device monitoring an input latency for each incremental user action, each input latency being an amount of time between consecutive incremental user actions, wherein the sizes of the subsequences are based on the input latency for incremental user actions.

6. The method of claim 5, wherein the first subsequence includes all incremental user actions for identifying the desired content items that are entered before the user pauses for a time greater than a predetermined threshold.

7. The method of claim 6, wherein the predetermined threshold is an average input latency for the user to incrementally input a user action.

8. The method of claim 1, further comprising at least one of the handheld client device and the remote server system monitoring an average network roundtrip latency, the average network roundtrip latency being an average amount of time for the remote server system to reply to a transmission from the handheld client device, wherein the sizes of the subsequences are based on the average network roundtrip latency.

9. The method of claim 1, wherein the handheld client device transmits a self-sufficient message to the remote server system, the self-sufficient message including the first subsequence and all relevant context for the first subsequence including previous subsequences, if any, so that the remote server system does not need information in a previous message to respond to the self-sufficient message.

10. The method of claim 1, wherein the handheld client device formats messages for transmission to the remote server system to be less than a predetermined size.

11. The method of claim 1, wherein the incremental input consists of text entry.

12. The method of claim 1, wherein the incremental input consists of browse actions.

13. The method of claim 1, wherein the incremental input includes text entry and browse actions.

14. The method of claim 1, wherein the incremental input includes ambiguous text input.

15. The method of claim 1, wherein the content items of at least one of the first and second set of content items are in a node arrangement format.

16. A method of reducing perceived network latency in processing a minimal prefix text search query or a browse action from an input constrained handheld client device and processed by a remote server system and presenting results therefrom, the method comprising:
the handheld client device receiving incremental input including a sequence of incremental user actions for identifying desired content items on the remote server system, the incremental input incrementally identifying descriptive terms associated with the desired content items;
the handheld client device transmitting a first subsequence of the incremental input to the remote server system;
the remote server system receiving the first subsequence and selecting a first set of content items based on the first subsequence and the descriptive terms associated with the content items and transmitting a reply including the first set of content items to the handheld client device;
the handheld client device transmitting a second subsequence of the incremental input to the remote server system, the second subsequence being larger than the first subsequence and including incremental input received by the handheld client device while it was waiting for the reply to the first subsequence;
the remote server system receiving the second subsequence and selecting a second set of content items based on the second subsequence and the descriptive terms associated with the content items and transmitting a reply including the second set of content items to the handheld client device;
the handheld client device receiving the first and second set of content items and aborting processing on the set of content items corresponding to the subsequence transmitted earlier in time;
the handheld client device selecting a third set of content items from the set of content items corresponding to the subsequence transmitted later in time based on a third subsequence of the incremental input; and
the handheld client device ordering the third set of content items for presentation in accordance with one or more criteria and presenting the ordered set to the user.

17. The method of claim 16, wherein the second subsequence and the third subsequence are the same subsequence.

18. The method of claim 16, wherein the third subsequence is larger than the second subsequence and includes incremental input received by the handheld client device while it was waiting for the reply to the second subsequence.
